(19) United States
(12) Patent Application Publication
(10) Pub. No.: US 2024/0402316 A1
(43) Pub. Date: Dec. 5, 2024

(54) 360 DEGREE LIDAR CROPPING

(71) Applicant: Motional AD LLC, Boston, MA (US)

(72) Inventors: William Buono, Boston, MA (US); Justin DAntonio, Boston, PA (US); Jeremy Myers, Dormont, MA (US)

(21) Appl. No.: 18/327,593

(22) Filed: Jun. 1, 2023

Related U.S. Application Data
(60) Provisional application No. 63/437,529, filed on Jan. 6, 2023.
(60) Provisional application No. 63/379,724, filed on Oct. 14, 2022.

(51) Int. Cl. G01S 7/497; G01S 17/89; G01S 17/931

(52) U.S. Cl. CPC G01S 7/497; G01S 17/89; G01S 17/931

(57) ABSTRACT

Provided are methods for 360 degree LiDAR cropping, which can include receiving, using at least one processor, data characterizing detection of a target by a LiDAR sensor, wherein the target is located within a field of view of detection of the sensor, and wherein the target and the sensor are coupled to or adjacent to a portion of the vehicle, determining, using the at least one processor, a modified field of view of the sensor, wherein the modified field of view is narrower than the field of view and wherein the determining is based on at least identifying one or more regions in the field of view that include the target, and providing, using the at least one processor, a calibration dataset that includes data associated with the modified field of view. Systems and computer program products are also provided.

### CROSS-REFERENCE TO RELATED APPLICATIONS

This application claims benefit of U.S. Provisional Patent Application No. 63/379,724 filed on Oct. 14, 2022, and entitled “360 DEGREE LIDAR CROPPING” and U.S. Provisional Patent Application No. 63/437,529 filed on Jan. 6, 2023, and entitled “360 DEGREE LIDAR CROPPING” which are incorporated herein by reference in their entireties.

### BACKGROUND

Three hundred and sixty degree time-of-flight LiDARs may be used on vehicles. The full field of view of these LiDARs is rarely usable and a per-sensor cropping of azimuth and elevation firing position is required.

### BRIEF DESCRIPTION OF THE FIGURES

FIG. 1 is an example environment in which a vehicle including one or more components of an autonomous system can be implemented;

FIG. 2 is a diagram of one or more systems of a vehicle including an autonomous system;

FIG. 3 is a diagram of components of one or more devices and/or one or more systems of FIGS. 1 and 2;

FIG. 4 is a diagram of certain components of an autonomous system;

FIGS. 5A-5D are diagrams of an implementation of a process for 360 degree LiDAR cropping; and

FIG. 6 is a flowchart of a process for 360 degree LiDAR cropping;

FIG. 7 is a diagram a LiDAR system having certain elevation and azimuth angles;

FIG. 8A is a diagram of an example implementation of nominal sensor field of view of a LiDAR system from a front view;

FIG. 8B is a diagram of an example implementation of nominal sensor field of view of a LiDAR system from an overhead view;

FIG. 9A is a diagram showing blind spots of a LiDAR system at a ground plane at a nominal position;

FIG. 9B is a diagram showing blind spots of a LiDAR system at a ground plane at a tolerance position; and

FIG. 10 is a flowchart of a process for 360 degree LiDAR cropping.

### DETAILED DESCRIPTION

In the following description numerous specific details are set forth in order to provide a thorough understanding of the present disclosure for the purposes of explanation. It will be apparent, however, that the embodiments described by the present disclosure can be practiced without these specific details. In some instances, well-known structures and devices are illustrated in block diagram form in order to avoid unnecessarily obscuring aspects of the present disclosure.

Specific arrangements or orderings of schematic elements, such as those representing systems, devices, modules, instruction blocks, data elements, and/or the like are illustrated in the drawings for ease of description. However, it will be understood by those skilled in the art that the specific ordering or arrangement of the schematic elements in the drawings is not meant to imply that a particular order or sequence of processing, or separation of processes, is required unless explicitly described as such. Further, the inclusion of a schematic element in a drawing is not meant to imply that such element is required in all embodiments or that the features represented by such element may not be included in or combined with other elements in some embodiments unless explicitly described as such.

Further, where connecting elements such as solid or dashed lines or arrows are used in the drawings to illustrate a connection, relationship, or association between or among two or more other schematic elements, the absence of any such connecting elements is not meant to imply that no connection, relationship, or association can exist. In other words, some connections, relationships, or associations between elements are not illustrated in the drawings so as not to obscure the disclosure. In addition, for ease of illustration, a single connecting element can be used to represent multiple connections, relationships or associations between elements. For example, where a connecting element represents communication of signals, data, or instructions (e.g., “software instructions”), it should be understood by those skilled in the art that such element can represent one or multiple signal paths (e.g., a bus), as may be needed, to affect the communication.

Although the terms first, second, third, and/or the like are used to describe various elements, these elements should not be limited by these terms. The terms first, second, third, and/or the like are used only to distinguish one element from another. For example, a first contact could be termed a second contact and, similarly, a second contact could be termed a first contact without departing from the scope of the described embodiments. The first contact and the second contact are both contacts, but they are not the same contact.

The terminology used in the description of the various described embodiments herein is included for the purpose of describing particular embodiments only and is not intended to be limiting. As used in the description of the various described embodiments and the appended claims, the singular forms “a,” “an” and “the” are intended to include the plural forms as well and can be used interchangeably with “one or more” or “at least one,” unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this description specify the presence of stated features, integers, steps, operations, elements, and/or components, but do not preclude the presence or addition of one or more other features, integers, steps, operations, elements, components, and/or groups thereof.

As used herein, the terms “communication” and “communicate” refer to at least one of the reception, receipt, transmission, transfer, provision, and/or the like of information (or information represented by, for example, data, signals, messages, instructions, commands, and/or the like). For one unit (e.g., a device, a system, a component of a device or system, combinations thereof, and/or the like) to be in communication with another unit means that the one unit is able to directly or indirectly receive information from and/or send (e.g., transmit) information to the other unit. This may refer to a direct or indirect connection that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and transmits the processed information to the second unit. In some embodiments, a message may refer to a network packet (e.g., a data packet and/or the like) that includes data.

As used herein, the term “if” is, optionally, construed to mean “when”, “upon”, “in response to determining,” “in response to detecting,” and/or the like, depending on the context. Similarly, the phrase “if it is determined” or “if [a stated condition or event] is detected” is, optionally, construed to mean “upon determining,” “in response to determining,” “upon detecting [the stated condition or event],” “in response to detecting [the stated condition or event],” and/or the like, depending on the context. Also, as used herein, the terms “has”, “have”, “having”, or the like are intended to be open-ended terms. Further, the phrase “based on” is intended to mean “based at least partially on” unless explicitly stated otherwise.

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments can be practiced without these specific details. In other instances, well-known methods, procedures, components, circuits, and networks have not been described in detail so as not to unnecessarily obscure aspects of the embodiments.

### General Overview

In some aspects and/or embodiments, systems, methods, and computer program products described herein include and/or implement cropping a field of view of a LiDAR system. Unusable portions of the field of view of a LiDAR system (e.g., portions of the field of view corresponding to the vehicle, a mirror on the vehicle, a tire of the vehicle, and/or the like) are removed by cropping the field of view (e.g., during a calibration process). When cropping the field of view, a target is positioned adjacent to the vehicle to identify a boundary of a field of view of a LiDAR sensor and the LiDAR sensor generates data associated with a point cloud. Portions of the field of view beyond the boundary (e.g., those portions overlapping the vehicle) can be removed (e.g., during the calibration process) by configuring the LiDAR sensor to crop the point cloud based on the boundary of the field of view prior to transmitting the point cloud for downstream use (e.g., by an autonomous vehicle system as described herein). Additionally, or alternatively, the autonomous system can be configured to crop the point cloud upon receipt of data associated with the point cloud. This cropping process can be performed on a per vehicle basis (e.g., on each vehicle coming off of a production line, on a particular vehicle during maintenance, etc.) and provides a uniquely cropped field of view based on each vehicle's particular dimensions and tolerances.

By virtue of the implementation of systems, methods, and computer program products described herein include techniques for 360 degree LiDAR cropping. Some of the advantages of these systems and techniques include the following. The ability to crop a LiDAR system's field of view on a per vehicle basis reduces blind spots that can be caused based on sensor mounting tolerances. Further, the ability to crop a LiDAR system's field of view on a per vehicle basis eases constraints on bracket design, which may allow for less expensive brackets to be employed. Additionally, as the cropping systems and methods described herein can be automated, assembly time and assembly line checking may be reduced. And, by virtue of the implementation of techniques described herein, undesired LiDAR returns (e.g., returns from highly-reflective surfaces such as mirrors, glass, or certain paints) can be avoided.

In some embodiments, the system may reduce blind spots from a generic cropping for all production vehicles. In some embodiments, the system may include an automated solution for the vehicle to learn the vehicle body and automatically detect the cropping angles.

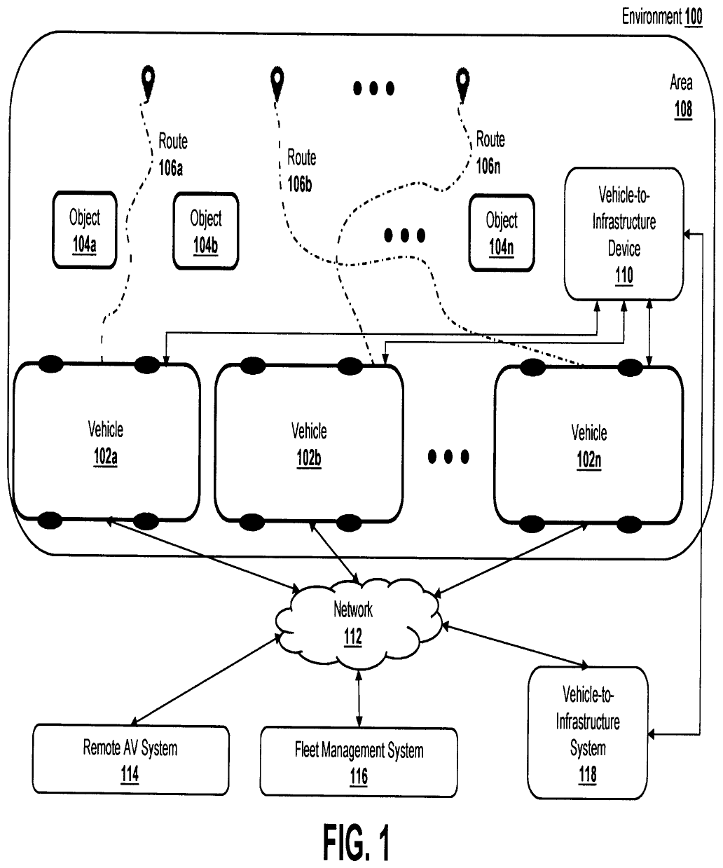

Referring now to FIG. 1, illustrated is example environment 100 in which vehicles that include autonomous systems, as well as vehicles that do not, are operated. As illustrated, environment 100 includes vehicles 102a-102n, objects 104a-104n, routes 106a-106n, area 108, vehicle-to-infrastructure (V2I) device 110, network 112, remote autonomous vehicle (AV) system 114, fleet management system 116, and V2I system 118. Vehicles 102a-102n, vehicle-to-infrastructure (V2I) device 110, network 112, autonomous vehicle (AV) system 114, fleet management system 116, and V2I system 118 interconnect (e.g., establish a connection to communicate and/or the like) via wired connections, wireless connections, or a combination of wired or wireless connections. In some embodiments, objects 104a-104n interconnect with at least one of vehicles 102a-102n, vehicle-to-infrastructure (V2I) device 110, network 112, autonomous vehicle (AV) system 114, fleet management system 116, and V2I system 118 via wired connections, wireless connections, or a combination of wired or wireless connections.

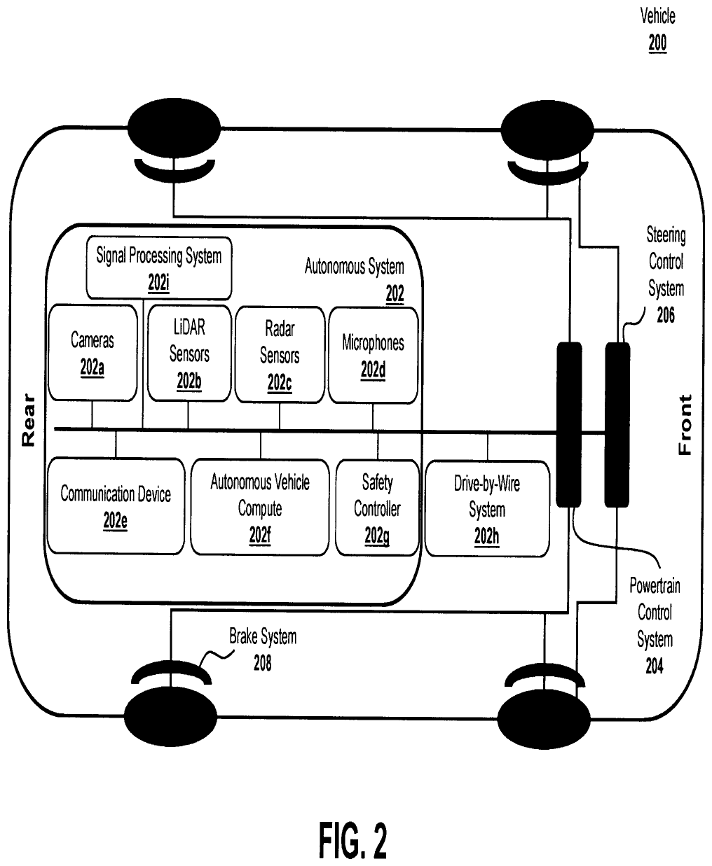

Vehicles 102a-102n (referred to individually as vehicle 102 and collectively as vehicles 102) include at least one device configured to transport goods and/or people. In some embodiments, vehicles 102 are configured to be in communication with V2I device 110, remote AV system 114, fleet management system 116, and/or V2I system 118 via network 112. In some embodiments, vehicles 102 include cars, buses, trucks, trains, and/or the like. In some embodiments, vehicles 102 are the same as, or similar to, vehicles 200, described herein (see FIG. 2). In some embodiments, a vehicle 200 of a set of vehicles 200 is associated with an autonomous fleet manager. In some embodiments, vehicles 102 travel along respective routes 106a-106n (referred to individually as route 106 and collectively as routes 106), as described herein. In some embodiments, one or more vehicles 102 include an autonomous system (e.g., an autonomous system that is the same as or similar to autonomous system 202).

Objects 104a-104n (referred to individually as object 104 and collectively as objects 104) include, for example, at least one vehicle, at least one pedestrian, at least one cyclist, at least one structure (e.g., a building, a sign, a fire hydrant, etc.), and/or the like. Each object 104 is stationary (e.g., located at a fixed location for a period of time) or mobile (e.g., having a velocity and associated with at least one trajectory). In some embodiments, objects 104 are associated with corresponding locations in area 108.

Routes 106a-106n (referred to individually as route 106 and collectively as routes 106) are each associated with (e.g., prescribe) a sequence of actions (also known as a trajectory) connecting states along which an AV can navigate. Each route 106 starts at an initial state (e.g., a state that corresponds to a first spatiotemporal location, velocity, and/or the like) and ends at a final goal state (e.g., a state that corresponds to a second spatiotemporal location that is different from the first spatiotemporal location) or goal region (e.g. a subspace of acceptable states (e.g., terminal states)). In some embodiments, the first state includes a location at which an individual or individuals are to be picked-up by the AV and the second state or region includes a location or locations at which the individual or individuals picked-up by the AV are to be dropped-off. In some embodiments, routes 106 include a plurality of acceptable state sequences (e.g., a plurality of spatiotemporal location sequences), the plurality of state sequences associated with (e.g., defining) a plurality of trajectories. In an example, routes 106 include only high level actions or imprecise state locations, such as a series of connected roads dictating turning directions at roadway intersections. Additionally, or alternatively, routes 106 may include more precise actions or states such as, for example, specific target lanes or precise locations within the lane areas and targeted speed at those positions. In an example, routes 106 include a plurality of precise state sequences along the at least one high level action sequence with a limited lookahead horizon to reach intermediate goals, where the combination of successive iterations of limited horizon state sequences cumulatively correspond to a plurality of trajectories that collectively form the high level route to terminate at the final goal state or region.

Area 108 includes a physical area (e.g., a geographic region) within which vehicles 102 can navigate. In an example, area 108 includes at least one state (e.g., a country, a province, an individual state of a plurality of states included in a country, etc.), at least one portion of a state, at least one city, at least one portion of a city, etc. In some embodiments, area 108 includes at least one named thoroughfare (referred to herein as a “road”) such as a highway, an interstate highway, a parkway, a city street, etc. Additionally, or alternatively, in some examples area 108 includes at least one unnamed road such as a driveway, a section of a parking lot, a section of a vacant and/or undeveloped lot, a dirt path, etc. In some embodiments, a road includes at least one lane (e.g., a portion of the road that can be traversed by vehicles 102). In an example, a road includes at least one lane associated with (e.g., identified based on) at least one lane marking.

Vehicle-to-Infrastructure (V2I) device 110 (sometimes referred to as a Vehicle-to-Infrastructure or Vehicle-to-Everything (V2X) device) includes at least one device configured to be in communication with vehicles 102 and/or V2I infrastructure system 118. In some embodiments, V2I device 110 is configured to be in communication with vehicles 102, remote AV system 114, fleet management system 116, and/or V2I system 118 via network 112. In some embodiments, V2I device 110 includes a radio frequency identification (RFID) device, signage, cameras (e.g., two-dimensional (2D) and/or three-dimensional (3D) cameras), lane markers, streetlights, parking meters, etc. In some embodiments, V2I device 110 is configured to communicate directly with vehicles 102. Additionally, or alternatively, in some embodiments V2I device 110 is configured to communicate with vehicles 102, remote AV system 114, and/or fleet management system 116 via V2I system 118. In some embodiments, V2I device 110 is configured to communicate with V2I system 118 via network 112.

Network 112 includes one or more wired and/or wireless networks. In an example, network 112 includes a cellular network (e.g., a long term evolution (LTE) network, a third generation (3G) network, a fourth generation (4G) network, a fifth generation (5G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN), a private network, an ad hoc network, an intranet, the Internet, a fiber optic-based network, a cloud computing network, etc., a combination of some or all of these networks, and/or the like.

Remote AV system 114 includes at least one device configured to be in communication with vehicles 102, V2I device 110, network 112, fleet management system 116, and/or V2I system 118 via network 112. In an example, remote AV system 114 includes a server, a group of servers, and/or other like devices. In some embodiments, remote AV system 114 is co-located with the fleet management system 116. In some embodiments, remote AV system 114 is involved in the installation of some or all of the components of a vehicle, including an autonomous system, an autonomous vehicle compute, software implemented by an autonomous vehicle compute, and/or the like. In some embodiments, remote AV system 114 maintains (e.g., updates and/or replaces) such components and/or software during the lifetime of the vehicle.

Fleet management system 116 includes at least one device configured to be in communication with vehicles 102, V2I device 110, remote AV system 114, and/or V2I infrastructure system 118. In an example, fleet management system 116 includes a server, a group of servers, and/or other like devices. In some embodiments, fleet management system 116 is associated with a ridesharing company (e.g., an organization that controls operation of multiple vehicles (e.g., vehicles that include autonomous systems and/or vehicles that do not include autonomous systems) and/or the like).

In some embodiments, V2I system 118 includes at least one device configured to be in communication with vehicles 102, V2I device 110, remote AV system 114, and/or fleet management system 116 via network 112. In some examples, V2I system 118 is configured to be in communication with V2I device 110 via a connection different from network 112. In some embodiments, V2I system 118 includes a server, a group of servers, and/or other like devices. In some embodiments, V2I system 118 is associated with a municipality or a private institution (e.g., a private institution that maintains V2I device 110 and/or the like).

The number and arrangement of elements illustrated in FIG. 1 are provided as an example. There can be additional elements, fewer elements, different elements, and/or differently arranged elements, than those illustrated in FIG. 1. Additionally, or alternatively, at least one element of environment 100 can perform one or more functions described as being performed by at least one different element of FIG. 1. Additionally, or alternatively, at least one set of elements of environment 100 can perform one or more functions described as being performed by at least one different set of elements of environment 100.

Referring now to FIG. 2, vehicle 200 (which may be the same as, or similar to vehicles 102 of FIG. 1) includes or is associated with autonomous system 202, powertrain control system 204, steering control system 206, and brake system 208. In some embodiments, vehicle 200 is the same as or similar to vehicle 102 (see FIG. 1). In some embodiments, autonomous system 202 is configured to confer vehicle 200 autonomous driving capability (e.g., implement at least one driving automation or maneuver-based function, feature, device, and/or the like that enable vehicle 200 to be partially or fully operated without human intervention including, without limitation, fully autonomous vehicles (e.g., vehicles that forego reliance on human intervention such as Level 5 ADS-operated vehicles), highly autonomous vehicles (e.g., vehicles that forego reliance on human intervention in certain situations such as Level 4 ADS-operated vehicles), conditional autonomous vehicles (e.g., vehicles that forego reliance on human intervention in limited situations such as Level 3 ADS-operated vehicles) and/or the like.

In one embodiment, autonomous system 202 includes operation or tactical functionality required to operate vehicle 200 in on-road traffic and perform part or all of Dynamic Driving Task (DDT) on a sustained basis. In another embodiment, autonomous system 202 includes an Advanced Driver Assistance System (ADAS) that includes driver support features. Autonomous system 202 supports various levels of driving automation, ranging from no driving automation (e.g., Level 0) to full driving automation (e.g., Level 5). For a detailed description of fully autonomous vehicles and highly autonomous vehicles, reference may be made to SAE International's standard J3016: Taxonomy and Definitions for Terms Related to On-Road Motor Vehicle Automated Driving Systems, which is incorporated by reference in its entirety. In some embodiments, vehicle 200 is associated with an autonomous fleet manager and/or a ridesharing company.

Autonomous system 202 includes a sensor suite that includes one or more devices such as cameras 202a, LiDAR sensors 202b, radar sensors 202c, and microphones 202d. In some embodiments, autonomous system 202 can include more or fewer devices and/or different devices (e.g., ultrasonic sensors, inertial sensors, GPS receivers (discussed below), odometry sensors that generate data associated with an indication of a distance that vehicle 200 has traveled, and/or the like). In some embodiments, autonomous system 202 uses the one or more devices included in autonomous system 202 to generate data associated with environment 100, described herein. The data generated by the one or more devices of autonomous system 202 can be used by one or more systems described herein to observe the environment (e.g., environment 100) in which vehicle 200 is located. In some embodiments, autonomous system 202 includes communication device 202e, autonomous vehicle compute 202f, drive-by-wire (DBW) system 202h, and safety controller 202g.

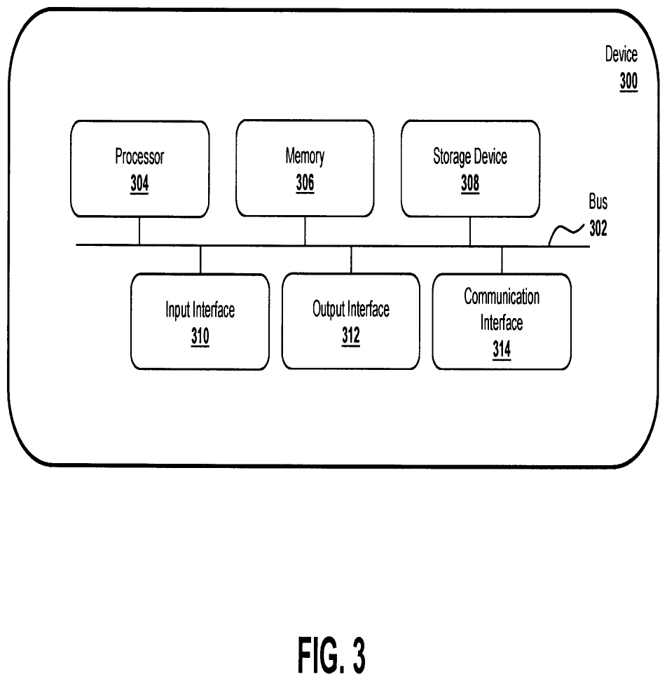

Cameras 202a include at least one device configured to be in communication with communication device 202e, autonomous vehicle compute 202f, and/or safety controller 202g via a bus (e.g., a bus that is the same as or similar to bus 302 of FIG. 3). Cameras 202a include at least one camera (e.g., a digital camera using a light sensor such as a Charged-Coupled Device (CCD), a thermal camera, an infrared (IR) camera, an event camera, and/or the like) to capture images including physical objects (e.g., cars, buses, curbs, people, and/or the like). In some embodiments, camera 202a generates camera data as output. In some examples, camera 202a generates camera data that includes image data associated with an image. In this example, the image data may specify at least one parameter (e.g., image characteristics such as exposure, brightness, etc., an image timestamp, and/or the like) corresponding to the image. In such an example, the image may be in a format (e.g., RAW, JPEG, PNG, and/or the like). In some embodiments, camera 202a includes a plurality of independent cameras configured on (e.g., positioned on) a vehicle to capture images for the purpose of stereopsis (stereo vision). In some examples, camera 202a includes a plurality of cameras that generate image data and transmit the image data to autonomous vehicle compute 202f and/or a fleet management system (e.g., a fleet management system that is the same as or similar to fleet management system 116 of FIG. 1). In such an example, autonomous vehicle compute 202f determines depth to one or more objects in a field of view of at least two cameras of the plurality of cameras based on the image data from the at least two cameras. In some embodiments, cameras 202a is configured to capture images of objects within a distance from cameras 202a (e.g., up to 100 meters, up to a kilometer, and/or the like). Accordingly, cameras 202a include features such as sensors and lenses that are optimized for perceiving objects that are at one or more distances from cameras 202a.

In an embodiment, camera 202a includes at least one camera configured to capture one or more images associated with one or more traffic lights, street signs and/or other physical objects that provide visual navigation information. In some embodiments, camera 202a generates traffic light data associated with one or more images. In some examples, camera 202a generates TLD (Traffic Light Detection) data associated with one or more images that include a format (e.g., RAW, JPEG, PNG, and/or the like). In some embodiments, camera 202a that generates TLD data differs from other systems described herein incorporating cameras in that camera 202a can include one or more cameras with a wide field of view (e.g., a wide-angle lens, a fish-eye lens, a lens having a viewing angle of approximately 120 degrees or more, and/or the like) to generate images about as many physical objects as possible.

Light Detection and Ranging (LiDAR) sensors 202b include at least one device configured to be in communication with communication device 202e, autonomous vehicle compute 202f, and/or safety controller 202g via a bus (e.g., a bus that is the same as or similar to bus 302 of FIG. 3). LiDAR sensors 202b include a system configured to transmit light from a light emitter (e.g., a laser transmitter). Light emitted by LiDAR sensors 202b include light (e.g., infrared light and/or the like) that is outside of the visible spectrum. In some embodiments, during operation, light emitted by LiDAR sensors 202b encounters a physical object (e.g., a vehicle) and is reflected back to LiDAR sensors 202b. In some embodiments, the light emitted by LiDAR sensors 202b does not penetrate the physical objects that the light encounters. LiDAR sensors 202b also include at least one light detector which detects the light that was emitted from the light emitter after the light encounters a physical object. In some embodiments, at least one signal processing system (e.g., signal processing system 202i) associated with LiDAR sensors 202b generates an image (e.g., a point cloud, a combined point cloud, and/or the like) representing the objects included in a field of view of LiDAR sensors 202b. In some examples, the at least one signal processing system associated with LiDAR sensor 202b generates an image that represents the boundaries of a physical object, the surfaces (e.g., the topology of the surfaces) of the physical object, and/or the like. In such an example, the image is used to determine the boundaries of physical objects in the field of view of LiDAR sensors 202b.

Radio Detection and Ranging (radar) sensors 202c include at least one device configured to be in communication with communication device 202e, autonomous vehicle compute 202f, and/or safety controller 202g via a bus (e.g., a bus that is the same as or similar to bus 302 of FIG. 3). Radar sensors 202c include a system configured to transmit radio waves (either pulsed or continuously). The radio waves transmitted by radar sensors 202c include radio waves that are within a predetermined spectrum In some embodiments, during operation, radio waves transmitted by radar sensors 202c encounter a physical object and are reflected back to radar sensors 202c. In some embodiments, the radio waves transmitted by radar sensors 202c are not reflected by some objects. In some embodiments, at least one signal processing system associated with radar sensors 202c generates signals representing the objects included in a field of view of radar sensors 202c. For example, the at least one signal processing system associated with radar sensor 202c generates an image that represents the boundaries of a physical object, the surfaces (e.g., the topology of the surfaces) of the physical object, and/or the like. In some examples, the image is used to determine the boundaries of physical objects in the field of view of radar sensors 202c.

Microphones 202d includes at least one device configured to be in communication with communication device 202e, autonomous vehicle compute 202f, and/or safety controller 202g via a bus (e.g., a bus that is the same as or similar to bus 302 of FIG. 3). Microphones 202d include one or more microphones (e.g., array microphones, external microphones, and/or the like) that capture audio signals and generate data associated with (e.g., representing) the audio signals. In some examples, microphones 202d include transducer devices and/or like devices. In some embodiments, one or more systems described herein can receive the data generated by microphones 202d and determine a position of an object relative to vehicle 200 (e.g., a distance and/or the like) based on the audio signals associated with the data.

Communication device 202e includes at least one device configured to be in communication with cameras 202a, LiDAR sensors 202b, radar sensors 202c, microphones 202d, autonomous vehicle compute 202f, safety controller 202g, and/or DBW (Drive-By-Wire) system 202h. For example, communication device 202e may include a device that is the same as or similar to communication interface 314 of FIG. 3. In some embodiments, communication device 202e includes a vehicle-to-vehicle (V2V) communication device (e.g., a device that enables wireless communication of data between vehicles).

Autonomous vehicle compute 202f include at least one device configured to be in communication with cameras 202a, LiDAR sensors 202b, radar sensors 202c, microphones 202d, communication device 202e, safety controller 202g, and/or DBW system 202h. In some examples, autonomous vehicle compute 202f includes a device such as a client device, a mobile device (e.g., a cellular telephone, a tablet, and/or the like), a server (e.g., a computing device including one or more central processing units, graphical processing units, and/or the like), and/or the like. In some embodiments, autonomous vehicle compute 202f is the same as or similar to autonomous vehicle compute 400, described herein. Additionally, or alternatively, in some embodiments autonomous vehicle compute 202f is configured to be in communication with an autonomous vehicle system (e.g., an autonomous vehicle system that is the same as or similar to remote AV system 114 of FIG. 1), a fleet management system (e.g., a fleet management system that is the same as or similar to fleet management system 116 of FIG. 1), a V2I device (e.g., a V2I device that is the same as or similar to V2I device 110 of FIG. 1), and/or a V2I system (e.g., a V2I system that is the same as or similar to V2I system 118 of FIG. 1).

Safety controller 202g includes at least one device configured to be in communication with cameras 202a, LiDAR sensors 202b, radar sensors 202c, microphones 202d, communication device 202e, autonomous vehicle computer 202f, and/or DBW system 202h. In some examples, safety controller 202g includes one or more controllers (electrical controllers, electromechanical controllers, and/or the like) that are configured to generate and/or transmit control signals to operate one or more devices of vehicle 200 (e.g., powertrain control system 204, steering control system 206, brake system 208, and/or the like). In some embodiments, safety controller 202g is configured to generate control signals that take precedence over (e.g., overrides) control signals generated and/or transmitted by autonomous vehicle compute 202f.

DBW system 202h includes at least one device configured to be in communication with communication device 202e and/or autonomous vehicle compute 202f. In some examples, DBW system 202h includes one or more controllers (e.g., electrical controllers, electromechanical controllers, and/or the like) that are configured to generate and/or transmit control signals to operate one or more devices of vehicle 200 (e.g., powertrain control system 204, steering control system 206, brake system 208, and/or the like). Additionally, or alternatively, the one or more controllers of DBW system 202h are configured to generate and/or transmit control signals to operate at least one different device (e.g., a turn signal, headlights, door locks, windshield wipers, and/or the like) of vehicle 200.

Signal processing system 202i includes at least one device configured to be in communication with LiDAR sensors 202b. In some embodiments, at least one signal processing system (e.g., signal processing system 202i) associated with LiDAR sensors 202b generates an image (e.g., a point cloud, a combined point cloud, and/or the like) representing the objects included in a field of view of LiDAR sensors 202b. In some examples, the at least one signal processing system 202i associated with LiDAR sensor 202b generates an image that represents the boundaries of a physical object, the surfaces (e.g., the topology of the surfaces) of the physical object, and/or the like. In such an example, the image is used to determine the boundaries of physical objects in the field of view of LiDAR sensors 202b. In some embodiments, the signal processing system 202i receives uncropped data (e.g., a full field of view of a LiDAR sensor) and applies a filter to the uncropped data. In some embodiments, this filter crops the field of view of the LiDAR sensor based on a calibration data set. In some embodiments, the cropped field of view is then sent to the LiDAR sensor such that the LiDAR sensor operates in view of the cropped field of view.

Powertrain control system 204 includes at least one device configured to be in communication with DBW system 202h. In some examples, powertrain control system 204 includes at least one controller, actuator, and/or the like. In some embodiments, powertrain control system 204 receives control signals from DBW system 202h and powertrain control system 204 causes vehicle 200 to make longitudinal vehicle motion, such as start moving forward, stop moving forward, start moving backward, stop moving backward, accelerate in a direction, decelerate in a direction or to make lateral vehicle motion such as performing a left turn, performing a right turn, and/or the like. In an example, powertrain control system 204 causes the energy (e.g., fuel, electricity, and/or the like) provided to a motor of the vehicle to increase, remain the same, or decrease, thereby causing at least one wheel of vehicle 200 to rotate or not rotate.

Steering control system 206 includes at least one device configured to rotate one or more wheels of vehicle 200. In some examples, steering control system 206 includes at least one controller, actuator, and/or the like. In some embodiments, steering control system 206 causes the front two wheels and/or the rear two wheels of vehicle 200 to rotate to the left or right to cause vehicle 200 to turn to the left or right. In other words, steering control system 206 causes activities necessary for the regulation of the y-axis component of vehicle motion.

Brake system 208 includes at least one device configured to actuate one or more brakes to cause vehicle 200 to reduce speed and/or remain stationary. In some examples, brake system 208 includes at least one controller and/or actuator that is configured to cause one or more calipers associated with one or more wheels of vehicle 200 to close on a corresponding rotor of vehicle 200. Additionally, or alternatively, in some examples brake system 208 includes an automatic emergency braking (AEB) system, a regenerative braking system, and/or the like.

In some embodiments, vehicle 200 includes at least one platform sensor (not explicitly illustrated) that measures or infers properties of a state or a condition of vehicle 200. In some examples, vehicle 200 includes platform sensors such as a global positioning system (GPS) receiver, an inertial measurement unit (IMU), a wheel speed sensor, a wheel brake pressure sensor, a wheel torque sensor, an engine torque sensor, a steering angle sensor, and/or the like. Although brake system 208 is illustrated to be located in the near side of vehicle 200 in FIG. 2, brake system 208 may be located anywhere in vehicle 200.

Referring now to FIG. 3, illustrated is a schematic diagram of a device 300. As illustrated, device 300 includes processor 304, memory 306, storage component 308, input interface 310, output interface 312, communication interface 314, and bus 302. In some embodiments, device 300 corresponds to at least one device of vehicles 102 (e.g., at least one device of a system of vehicles 102), and/or one or more devices of network 112 (e.g., one or more devices of a system of network 112). In some embodiments, one or more devices of vehicles 102 (e.g., one or more devices of a system of vehicles 102), and/or one or more devices of network 112 (e.g., one or more devices of a system of network 112) include at least one device 300 and/or at least one component of device 300. As shown in FIG. 3, device 300 includes bus 302, processor 304, memory 306, storage component 308, input interface 310, output interface 312, and communication interface 314.

Bus 302 includes a component that permits communication among the components of device 300. In some cases, processor 304 includes a processor (e.g., a central processing unit (CPU), a graphics processing unit (GPU), an accelerated processing unit (APU), and/or the like), a microphone, a digital signal processor (DSP), and/or any processing component (e.g., a field-programmable gate array (FPGA), an application specific integrated circuit (ASIC), and/or the like) that can be programmed to perform at least one function. Memory 306 includes random access memory (RAM), read-only memory (ROM), and/or another type of dynamic and/or static storage device (e.g., flash memory, magnetic memory, optical memory, and/or the like) that stores data and/or instructions for use by processor 304.

Storage component 308 stores data and/or software related to the operation and use of device 300. In some examples, storage component 308 includes a hard disk (e.g., a magnetic disk, an optical disk, a magneto-optic disk, a solid state disk, and/or the like), a compact disc (CD), a digital versatile disc (DVD), a floppy disk, a cartridge, a magnetic tape, a CD-ROM, RAM, PROM, EPROM, FLASH-EPROM, NV-RAM, and/or another type of computer readable medium, along with a corresponding drive.

Input interface 310 includes a component that permits device 300 to receive information, such as via user input (e.g., a touchscreen display, a keyboard, a keypad, a mouse, a button, a switch, a microphone, a camera, and/or the like). Additionally or alternatively, in some embodiments input interface 310 includes a sensor that senses information (e.g., a global positioning system (GPS) receiver, an accelerometer, a gyroscope, an actuator, and/or the like). Output interface 312 includes a component that provides output information from device 300 (e.g., a display, a speaker, one or more light-emitting diodes (LEDs), and/or the like).

In some embodiments, communication interface 314 includes a transceiver-like component (e.g., a transceiver, a separate receiver and transmitter, and/or the like) that permits device 300 to communicate with other devices via a wired connection, a wireless connection, or a combination of wired and wireless connections. In some examples, communication interface 314 permits device 300 to receive information from another device and/or provide information to another device. In some examples, communication interface 314 includes an Ethernet interface, an optical interface, a coaxial interface, an infrared interface, a radio frequency (RF) interface, a universal serial bus (USB) interface, a Wi-Fi® interface, a cellular network interface, and/or the like.

In some embodiments, device 300 performs one or more processes described herein. Device 300 performs these processes based on processor 304 executing software instructions stored by a computer-readable medium, such as memory 305 and/or storage component 308. A computer-readable medium (e.g., a non-transitory computer readable medium) is defined herein as a non-transitory memory device. A non-transitory memory device includes memory space located inside a single physical storage device or memory space spread across multiple physical storage devices.

In some embodiments, software instructions are read into memory 306 and/or storage component 308 from another computer-readable medium or from another device via communication interface 314. When executed, software instructions stored in memory 306 and/or storage component 308 cause processor 304 to perform one or more processes described herein. Additionally or alternatively, hardwired circuitry is used in place of or in combination with software instructions to perform one or more processes described herein. Thus, embodiments described herein are not limited to any specific combination of hardware circuitry and software unless explicitly stated otherwise.

Memory 306 and/or storage component 308 includes data storage or at least one data structure (e.g., a database and/or the like). Device 300 is capable of receiving information from, storing information in, communicating information to, or searching information stored in the data storage or the at least one data structure in memory 306 or storage component 308. In some examples, the information includes network data, input data, output data, or any combination thereof.

In some embodiments, device 300 is configured to execute software instructions that are either stored in memory 306 and/or in the memory of another device (e.g., another device that is the same as or similar to device 300). As used herein, the term “module” refers to at least one instruction stored in memory 306 and/or in the memory of another device that, when executed by processor 304 and/or by a processor of another device (e.g., another device that is the same as or similar to device 300) cause device 300 (e.g., at least one component of device 300) to perform one or more processes described herein. In some embodiments, a module is implemented in software, firmware, hardware, and/or the like.

The number and arrangement of components illustrated in FIG. 3 are provided as an example. In some embodiments, device 300 can include additional components, fewer components, different components, or differently arranged components than those illustrated in FIG. 3. Additionally or alternatively, a set of components (e.g., one or more components) of device 300 can perform one or more functions described as being performed by another component or another set of components of device 300.

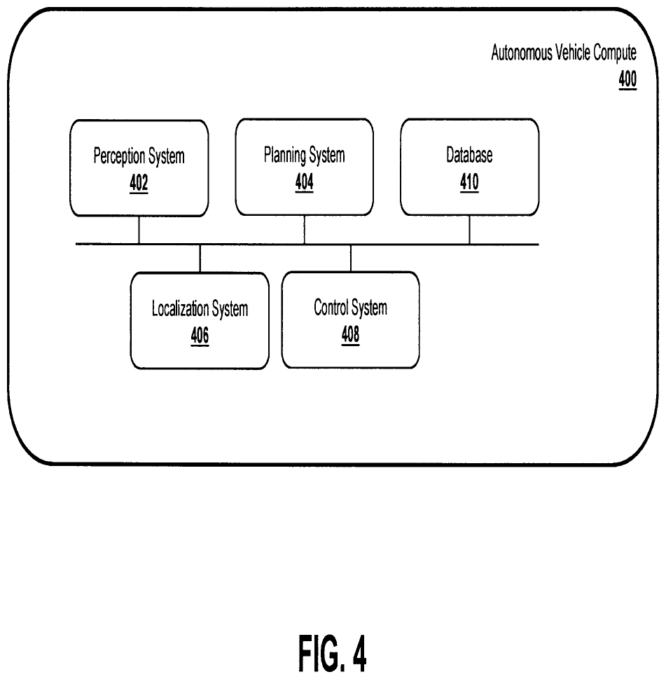

Referring now to FIG. 4, illustrated is an example block diagram of an autonomous vehicle compute 400 (sometimes referred to as an “AV stack”). As illustrated, autonomous vehicle compute 400 includes perception system 402 (sometimes referred to as a perception module), planning system 404 (sometimes referred to as a planning module), localization system 406 (sometimes referred to as a localization module), control system 408 (sometimes referred to as a control module), and database 410. In some embodiments, perception system 402, planning system 404, localization system 406, control system 408, and database 410 are included and/or implemented in an autonomous navigation system of a vehicle (e.g., autonomous vehicle compute 202f of vehicle 200). Additionally, or alternatively, in some embodiments perception system 402, planning system 404, localization system 406, control system 408, and database 410 are included in one or more standalone systems (e.g., one or more systems that are the same as or similar to autonomous vehicle compute 400 and/or the like). In some examples, perception system 402, planning system 404, localization system 406, control system 408, and database 410 are included in one or more standalone systems that are located in a vehicle and/or at least one remote system as described herein. In some embodiments, any and/or all of the systems included in autonomous vehicle compute 400 are implemented in software (e.g., in software instructions stored in memory), computer hardware (e.g., by microprocessors, microcontrollers, application-specific integrated circuits (ASICs), Field Programmable Gate Arrays (FPGAs), and/or the like), or combinations of computer software and computer hardware. It will also be understood that, in some embodiments, autonomous vehicle compute 400 is configured to be in communication with a remote system (e.g., an autonomous vehicle system that is the same as or similar to remote AV system 114, a fleet management system 116 that is the same as or similar to fleet management system 116, a V2I system that is the same as or similar to V2I system 118, and/or the like).

In some embodiments, perception system 402 receives data associated with at least one physical object (e.g., data that is used by perception system 402 to detect the at least one physical object) in an environment and classifies the at least one physical object. In some examples, perception system 402 receives image data captured by at least one camera (e.g., cameras 202a), the image associated with (e.g., representing) one or more physical objects within a field of view of the at least one camera. In such an example, perception system 402 classifies at least one physical object based on one or more groupings of physical objects (e.g., bicycles, vehicles, traffic signs, pedestrians, and/or the like). In some embodiments, perception system 402 transmits data associated with the classification of the physical objects to planning system 404 based on perception system 402 classifying the physical objects.

In some embodiments, planning system 404 receives data associated with a destination and generates data associated with at least one route (e.g., routes 106) along which a vehicle (e.g., vehicles 102) can travel along toward a destination. In some embodiments, planning system 404 periodically or continuously receives data from perception system 402 (e.g., data associated with the classification of physical objects, described above) and planning system 404 updates the at least one trajectory or generates at least one different trajectory based on the data generated by perception system 402. In other words, planning system 404 may perform tactical function-related tasks that are required to operate vehicle 102 in on-road traffic. Tactical efforts involve maneuvering the vehicle in traffic during a trip, including but not limited to deciding whether and when to overtake another vehicle, change lanes, or selecting an appropriate speed, acceleration, deacceleration, etc. In some embodiments, planning system 404 receives data associated with an updated position of a vehicle (e.g., vehicles 102) from localization system 406 and planning system 404 updates the at least one trajectory or generates at least one different trajectory based on the data generated by localization system 406.

In some embodiments, localization system 406 receives data associated with (e.g., representing) a location of a vehicle (e.g., vehicles 102) in an area. In some examples, localization system 406 receives LiDAR data associated with at least one point cloud generated by at least one LiDAR sensor (e.g., LiDAR sensors 202b). In certain examples, localization system 406 receives data associated with at least one point cloud from multiple LiDAR sensors and localization system 406 generates a combined point cloud based on each of the point clouds. In these examples, localization system 406 compares the at least one point cloud or the combined point cloud to two-dimensional (2D) and/or a three-dimensional (3D) map of the area stored in database 410. Localization system 406 then determines the position of the vehicle in the area based on localization system 406 comparing the at least one point cloud or the combined point cloud to the map. In some embodiments, the map includes a combined point cloud of the area generated prior to navigation of the vehicle. In some embodiments, maps include, without limitation, high-precision maps of the roadway geometric properties, maps describing road network connectivity properties, maps describing roadway physical properties (such as traffic speed, traffic volume, the number of vehicular and cyclist traffic lanes, lane width, lane traffic directions, or lane marker types and locations, or combinations thereof), and maps describing the spatial locations of road features such as crosswalks, traffic signs or other travel signals of various types. In some embodiments, the map is generated in real-time based on the data received by the perception system.

In another example, localization system 406 receives Global Navigation Satellite System (GNSS) data generated by a global positioning system (GPS) receiver. In some examples, localization system 406 receives GNSS data associated with the location of the vehicle in the area and localization system 406 determines a latitude and longitude of the vehicle in the area. In such an example, localization system 406 determines the position of the vehicle in the area based on the latitude and longitude of the vehicle. In some embodiments, localization system 406 generates data associated with the position of the vehicle. In some examples, localization system 406 generates data associated with the position of the vehicle based on localization system 406 determining the position of the vehicle. In such an example, the data associated with the position of the vehicle includes data associated with one or more semantic properties corresponding to the position of the vehicle.

In some embodiments, control system 408 receives data associated with at least one trajectory from planning system 404 and control system 408 controls operation of the vehicle. In some examples, control system 408 receives data associated with at least one trajectory from planning system 404 and control system 408 controls operation of the vehicle by generating and transmitting control signals to cause a powertrain control system (e.g., DBW system 202h, powertrain control system 204, and/or the like), a steering control system (e.g., steering control system 206), and/or a brake system (e.g., brake system 208) to operate. For example, control system 408 is configured to perform operational functions such as a lateral vehicle motion control or a longitudinal vehicle motion control. The lateral vehicle motion control causes activities necessary for the regulation of the y-axis component of vehicle motion. The longitudinal vehicle motion control causes activities necessary for the regulation of the x-axis component of vehicle motion. In an example, where a trajectory includes a left turn, control system 408 transmits a control signal to cause steering control system 206 to adjust a steering angle of vehicle 200, thereby causing vehicle 200 to turn left. Additionally, or alternatively, control system 408 generates and transmits control signals to cause other devices (e.g., headlights, turn signal, door locks, windshield wipers, and/or the like) of vehicle 200 to change states.

In some embodiments, perception system 402, planning system 404, localization system 406, and/or control system 408 implement at least one machine learning model (e.g., at least one multilayer perceptron (MLP), at least one convolutional neural network (CNN), at least one recurrent neural network (RNN), at least one autoencoder, at least one transformer, and/or the like). In some examples, perception system 402, planning system 404, localization system 406, and/or control system 408 implement at least one machine learning model alone or in combination with one or more of the above-noted systems. In some examples, perception system 402, planning system 404, localization system 406, and/or control system 408 implement at least one machine learning model as part of a pipeline (e.g., a pipeline for identifying one or more objects located in an environment and/or the like).

Database 410 stores data that is transmitted to, received from, and/or updated by perception system 402, planning system 404, localization system 406 and/or control system 408. In some examples, database 410 includes a storage component (e.g., a storage component that is the same as or similar to storage component 308 of FIG. 3) that stores data and/or software related to the operation and uses at least one system of autonomous vehicle compute 400. In some embodiments, database 410 stores data associated with 2D and/or 3D maps of at least one area. In some examples, database 410 stores data associated with 2D and/or 3D maps of a portion of a city, multiple portions of multiple cities, multiple cities, a county, a state, a State (e.g., a country), and/or the like). In such an example, a vehicle (e.g., a vehicle that is the same as or similar to vehicles 102 and/or vehicle 200) can drive along one or more drivable regions (e.g., single-lane roads, multi-lane roads, highways, back roads, off road trails, and/or the like) and cause at least one LiDAR sensor (e.g., a LiDAR sensor that is the same as or similar to LiDAR sensors 202b) to generate data associated with an image representing the objects included in a field of view of the at least one LiDAR sensor.

In some embodiments, database 410 can be implemented across a plurality of devices. In some examples, database 410 is included in a vehicle (e.g., a vehicle that is the same as or similar to vehicles 102 and/or vehicle 200), an autonomous vehicle system (e.g., an autonomous vehicle system that is the same as or similar to remote AV system 114, a fleet management system (e.g., a fleet management system that is the same as or similar to fleet management system 116 of FIG. 1, a V2I system (e.g., a V2I system that is the same as or similar to V2I system 118 of FIG. 1) and/or the like.

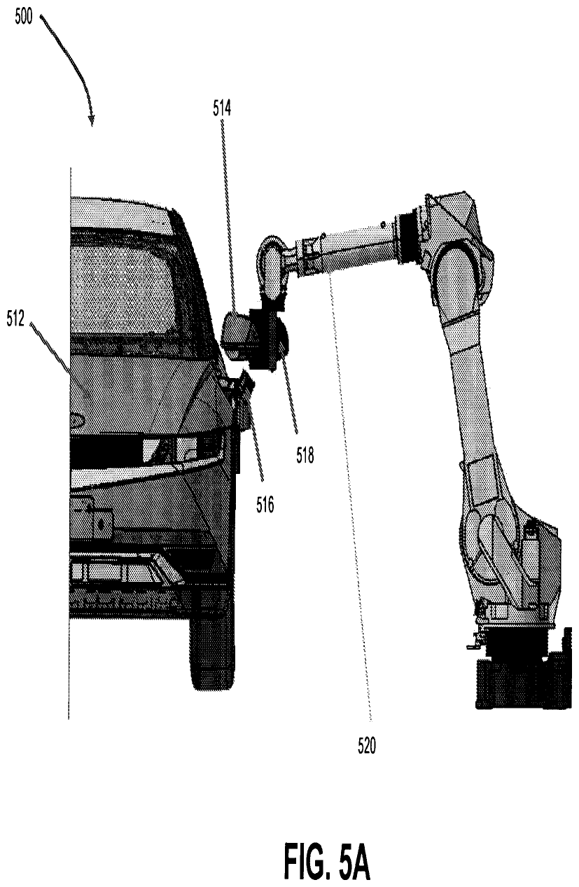

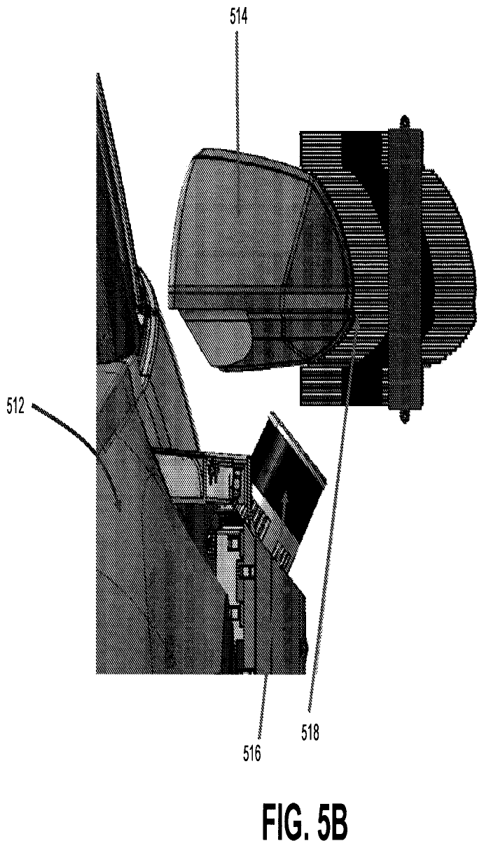

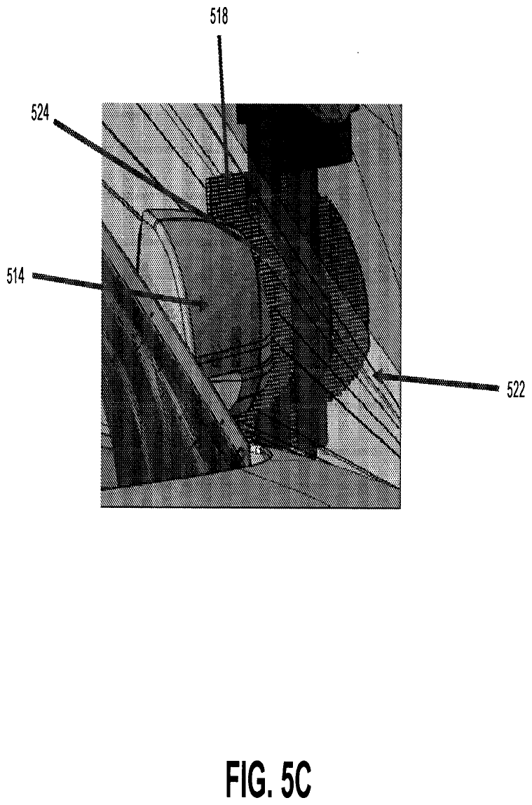

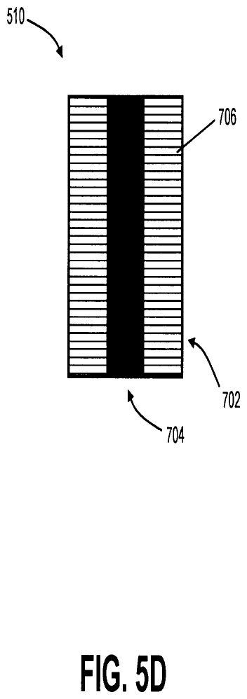

Referring now to FIGS. 5A-5D, illustrated is an implementation 500 of a technique for 360-degree LiDAR cropping. In some embodiments, implementation 500 includes a vehicle 512 having one or more portions, e.g., mirror 514. The vehicle 512 includes a LiDAR sensor 516 mounted thereon. The full field of view of the LiDAR sensor 516 is not usable as a portion of the field of view overlaps the body or portions (e.g., mirror 514) of the vehicle. To determine which beams of the LiDAR sensor 516 need to be turned off or ignored, a calibration process is implemented to crop the field of view. The calibration process includes placing a target 518 against the vehicle and, in some embodiments, is held and placed using a robotic arm 520. In some implementations, the robotic arm 520 is part of a manufacturing line for the vehicle 512. In some embodiments, an operator positions the target 518 against the portion of the vehicle in addition to or instead of robotic arm 520. For example, at a repair facility, target placement is more likely to be manually done whereas in a manufacturing setting it may be advantageous to implement robotic target placement. In some embodiments, the target and/or the sensor are coupled to (e.g., removably or permanently attached) to the body of the vehicle 512. In some embodiments, the target and/or the sensor are adjacent to the body of the vehicle 512. In FIGS. 5A-5C, the portion of the vehicle is a mirror. In some embodiments, the portion of the vehicle is a side panel, a fender, etc. In some embodiments, the robotic arm is registered to the vehicle and/or components involved in the cropping process.

As shown in FIGS. 5A-5C, the target 518 conforms to the shape of the portion of the vehicle (e.g., mirror 516) that the target is placed against. In some embodiments, as shown in FIG. 5D, the target is a colored contour gauge that conforms to the shape of the vehicle. The target includes alternating zones of high and low reflectivity to assist in calibration. In some examples, the alternating zones of high and low reflectivity are alternating black and white colored bands that run perpendicular to the fingers 706 of the contour gauge. The target 518 is placed within the field of detection of the LiDAR sensor (e.g., the beams from the LiDAR sensor can reach the target). The alternating zones of high (702) and low (704) reflectivity provide multiple points of measurement (e.g., a measurement is taken from each band on the target) to improve confidence in the measurements taken by the LiDAR sensor to determine the cropping. For example, a signal processing system (e.g., the signal processing system 202i associated with the LiDAR sensors 202b) that is implemented to determine the cropping, expects to see, in the point cloud generated by the LiDAR sensor, from right to left, an area of high reflectivity, an area of low reflectivity, and another area of high reflectivity. In some embodiments, if this pattern is not observed, an error is noted.

In some embodiments, the target has another pattern of reflectivity. For example, the target may have a low-high-low pattern of reflectivity.

In some embodiments, the measurements (e.g., LiDAR data) taken are sent to a signal processing system 202i to be interpreted and the signal processing system 202i outputs LiDAR calibration data for cropping the field of view. In some embodiments, the signal processing system 202i is part of autonomous system 202. In some embodiments, the signal processing system 202i is the same as or similar to the device 300 of FIG. 3. In some embodiments, the LiDAR calibration data is sent to the firmware of the LiDAR sensor so that the cropping is implemented. In some embodiments, the LiDAR calibration data is received and implemented via one or more software processes that ignores returns for one or more of the LiDAR beams. In some embodiments, the calibration data includes instructions for turning off and/or ignoring returns for one or more beams of the LiDAR sensor causing the LiDAR sensor to transmit or forgo transmission of signals at a certain point and location (e.g., during a burst or a sweep of laser emissions). In some embodiments, deactivation of particular beams is advantageous to reduce the effects of scatter from those beams if they were to be left on and the returns ignored.

Referring to FIG. 5C, beams 522 are emitted by LiDAR sensor 516 (shown in FIGS. 5A-5B) and cropped, represented by arrow 524. The beams 522 are cropped to maximize coverage of the beams without covering the vehicle 512. Because the cropping is done on a per car basis, the tolerances of the LiDAR sensor (e.g., a small discrepancy which occurs during sensor mounting), is accounted for in determining the cropping and therefore the field of view (FoV) of the sensor. In some embodiments, a yaw tolerance is accounted for in determining the cropping.

In some embodiments, for a LiDAR sensor mounted to the side of the vehicle, three different target placements occur to determine the cropped FoV, one at the front, one at the rear, and one for the mirror. In other embodiments, any appropriate number of target placements may occur based on the particular geometry of the vehicle on which the LiDAR sensor is mounted. For example, a front placement for a target for a side-mounted LiDAR sensor is against the front fender and a rear placement is along the rear quarter panel. Placement of the target at these key areas allows for extrapolation of the geometry of other portions of the vehicle due, at least in part to, the rigidity of other portions of the vehicle.

In some embodiments, for a LiDAR sensor mounted at a front or a rear of the vehicle, two different target placements occur to determine the cropped FoV, one on the left of the sensor and one on the right. In other embodiments, any appropriate number of target placements may occur based on the particular geometry of the vehicle on which the LiDAR sensor is mounted.

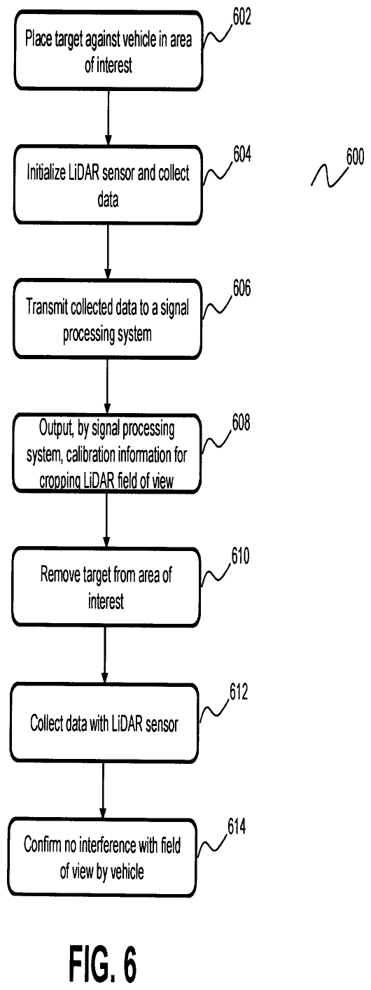

Referring now to FIG. 6, illustrated is a flowchart of a process 600 for 360-degree LiDAR cropping. In some embodiments, one or more of the steps described with respect to process 600 are performed (e.g., completely, partially, and/or the like) by an autonomous system. In some embodiments, a robotic arm (e.g., robotic arm 520 of FIGS. 5A-5C), a LiDAR sensor (e.g., LiDAR sensor 516), and a signal processing system (e.g., the signal processing system 202i associated with the LiDAR sensors 202b) coordinate to carry out an automated process, which includes placing the target with the robotic arm, taking the measurement with the LiDAR sensor, processing the LiDAR data and determining the calibration with the signal processing system, and implementing the calibration on the LiDAR sensor (either via firmware or software) to create the modified field of view. Additionally, or alternatively, in some embodiments one or more steps described with respect to process 600 are performed (e.g., completely, partially, and/or the like) by another device or group of devices separate from or including an autonomous system.

The process 600 includes placing (block 602) a target (e.g., target 518 shown in FIGS. 5A-5C) against a vehicle area of interest (e.g., mirror 514 of FIGS. 5A-5C). In some embodiments, the target may change shape to conform to the shape of the vehicle area of interest.

The process 600 also includes initializing (block 604) a LiDAR sensor (e.g., LiDAR sensor 516 of FIGS. 5A-5C) and collecting data. The LiDAR sensor emits beams and collects a point cloud that includes beams that have hit the target.

The process 600 also includes transmitting (block 606) the collected data to a signal processing system, e.g., signal processing system 202i of FIG. 2. The collected data includes data related to the LiDAR sensor's emitted beams that have hit the target (e.g., target 518 of FIGS. 5A-5C). In some embodiments, the signal processing system is part of a perception system, e.g., perception system 402 of autonomous vehicle compute 400 of FIG. 4, that receives the full data set (e.g., the uncropped data set) and applies a filter to the full data set before running the data through the perception pipeline.

The process 600 also includes outputting (block 608), by the signal processing system (e.g., signal processing system 202i associated with LiDAR sensors 202b), calibration information for cropping a LiDAR field of view. This calibration information is based on the collected data. The calibration data is generated by looking for the pattern of the target and determining, based on that pattern and the measurements taken, where the vehicle portion is and where beams of the LiDAR sensor would contact the vehicle. In some embodiments, the calibration data includes instructions for turning off and/or ignoring returns for one or more beams of the LiDAR sensor. In some embodiments, the calibration information is sent to the firmware of the LiDAR sensor for implementation and beams may be turned on or turned off. In other embodiments, the calibration information is implemented via software and the output of one or more beams of the LiDAR sensor are ignored. In some embodiments, turning off particular beams is advantageous to reduce the effects of scatter from those beams if they were to be left on and the returns ignored.

The process 600 also includes removing (block 610) the target (e.g., target 518 from FIGS. 5A-5C) from the area of interest (e.g., mirror 514).

The process 600 also includes collecting (block 612) data with the LiDAR sensor. This data collection step includes, for example, generating a new point cloud with the LiDAR sensor after the calibration information is received and implemented by either a signal processing system associated with the LiDAR sensor (e.g., the signal processing system 202i associated with LiDAR sensors 202b) or firmware of the LiDAR sensor.

The process 600 also includes confirming (block 614) no interference with the field of view by the vehicle. For example, this step may include checking that the cropping calibration that was applied is correct (e.g., that the vehicle is not in the modified field of view).

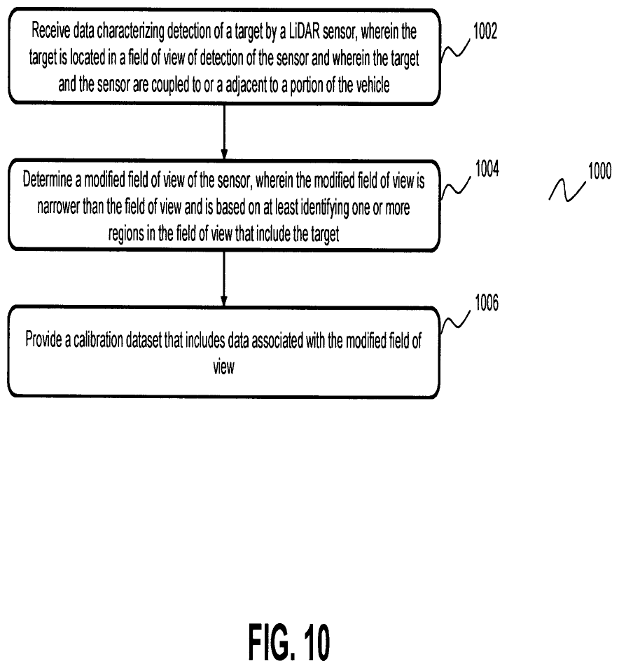

In some embodiments, the system may reduce blind spots from a generic cropping for all production vehicles. In some embodiments, the system includes an automated solution for the vehicle to learn the vehicle body and automatically detect the cropping angles. In some embodiments, the system is part of a fully-automated production line for a vehicle platform. In these embodiments, the robot and/or the target is equipped with one or more additional sensors configured to, for example, provide feedback when the target has been placed at an appropriate position on the vehicle body. After the feedback is received that the target has been appropriately placed, the remaining steps shown and described with respect to FIG. 6 and/or FIG. 10 may be performed. The movement of the robot, and therefore the target, can be programmed such that all appropriate target placements along the vehicle body are performed. In some embodiments, multiple robots and/or targets are used to complete all required placements against the vehicle body. In some embodiments, two side mounted robots are used for target placement. In some embodiments, one overhead robot is used for target placement.

In some embodiments, a known shape of a vehicle body and known locations of the LiDAR sensors thereon can be used to determine a placement protocol including instructions for placing the targets at particular locations by the automated system. In some embodiments, the placement protocol is executed by the automated system and moves the targets to specific locations in a predetermined order and/or for a predetermined amount of time.

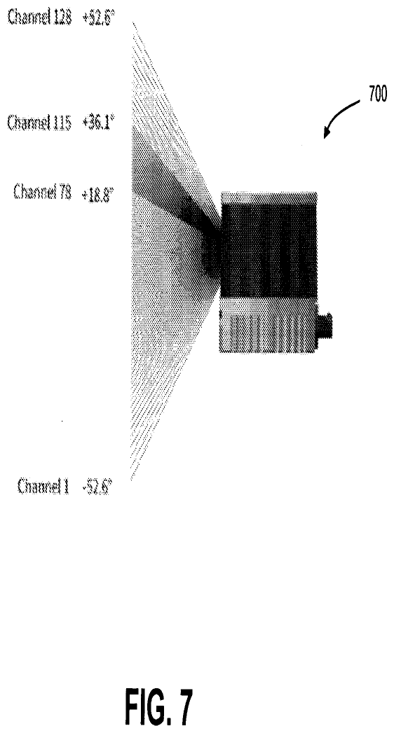

FIG. 7 is a diagram showing certain elevation angles of a LiDAR system. In an example, LiDAR system 700 is a 360 degree mechanically rotating LiDAR with 128 channels. The LiDAR system 700 has a range of 0.1 to 50 meters, with a range capability of 0.1 to 20 meters at 10% reflectivity. The LiDAR system 700 has a range accuracy of approximately +/−3 cm. The LiDAR system 700 has a 360 degree horizontal field of view and a vertical field of view of 105.2° (−52.6° to +52.6°). In some embodiments, the resolution may be as fine as 0.4°. The LiDAR system 700 is single return (e.g., using a first return or a last return) or dual return (e.g., using a first return and a last return). Generally, 360° LiDARs have discrete azimuth and elevation angles of measurement. In some embodiments, these firing positions can be turned on or off in the sensor firmware depending on their usability in the sensor application. It is these firing positions that may be turned on, turned off, or ignored based on their interaction with the target and/or vehicle.

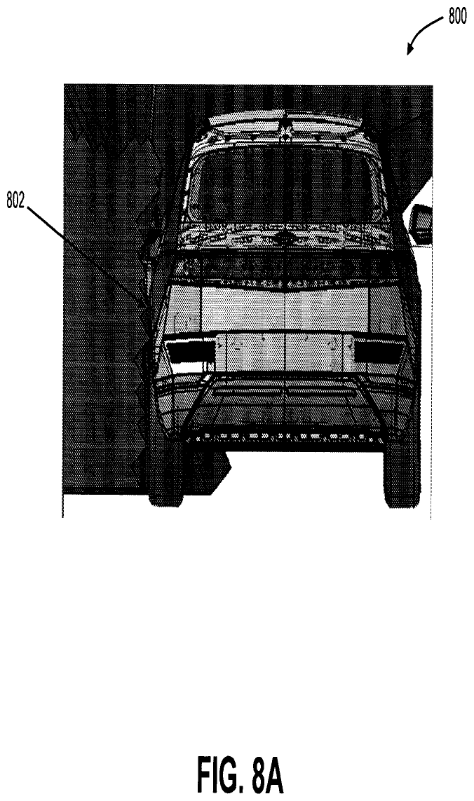

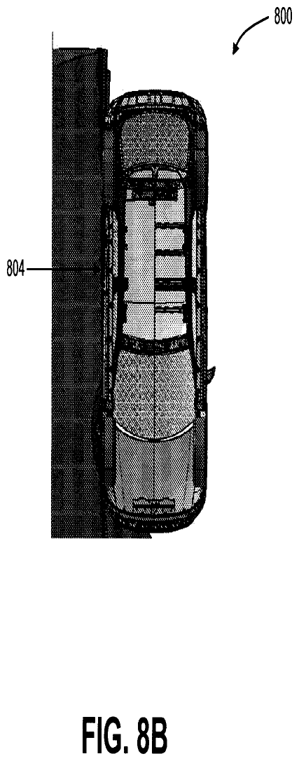

FIG. 8A is a diagram of an example implementation 800 of nominal sensor field of view of a LiDAR system from a rear view of a vehicle. The beams 802 as cropped approximate the contour of the vehicle body as shown. FIG. 8B is a diagram of an example implementation 800 of nominal sensor field of view of a LiDAR system from an overhead view of a vehicle. The beams 802 as cropped approximate the contour of the vehicle body as shown.

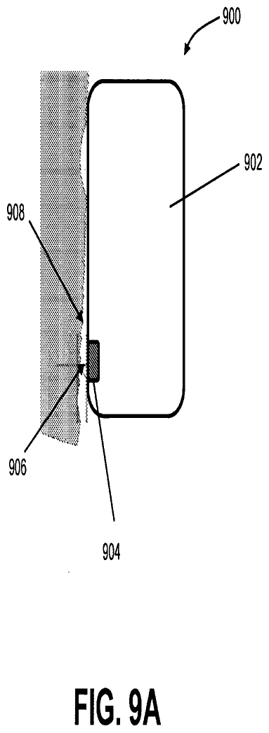

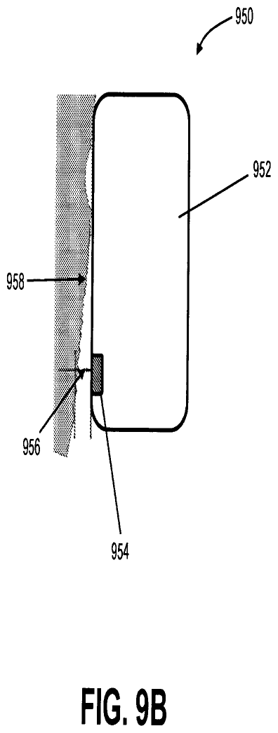

FIG. 9A is a diagram showing blind spots of a LiDAR system at a ground plane at a nominal position. In implementation 900, at the rear wheel 904 of the vehicle 902, a gap 906 between coverage of the LiDAR beams 908 and the vehicle 902 is a blind spot for the LiDAR sensor. The blind spot is nominally approximately 216 mm from the rear wheel 904.

FIG. 9B is a diagram showing blind spots of a LiDAR system at a ground plane at a tolerance position. In implementation 950, at the rear wheel 954 of the vehicle 952, a gap 956 between coverage of the LiDAR beams 958 and the vehicle 952 is a blind spot for the LiDAR sensor. This blind spot opens when the yaw error rotates the short range LiDAR away from the rear quarter panel. As previously mentioned, the blind spot is nominally approximately 216 mm and increases to approximately 382 mm with tolerance stack up near the rear wheel. In another embodiment, for example, if the tolerance swings the other direction (e.g., when the yaw error rotates the short range LiDAR toward the rear quarter panel) the LiDAR sensor will see the vehicle body and read that an occlusion exists at the location. If this occurs, the vehicle thinks that an object is in the near field even when no object is present. In such a case, this false object detection will prevent a vehicle from moving when there is no object present. In an embodiment of a robotaxi, for example, this false detection could cause the robotaxi to not pull away from a pickup.

The systems and methods described above help to eliminate or reduce this blind spot such that blind spots and false occlusion detections do not occur. This applies directly to cameras and LiDARs. Generally, smaller values for known blind spots are preferred for perception and safety reasons.

Referring to FIG. 10, illustrated is a flowchart of a process 1000 for 360-degree LiDAR cropping. The process includes receiving (block 1002) data characterizing detection of a target (e.g., target 518 of FIGS. 5A-5D) by a LiDAR sensor (e.g., LiDAR sensor 516 of FIGS. 5A-5C), wherein the target is located within a field of view of detection of the sensor (e.g., beams from the sensor can reach the target), and wherein the target and the sensor are coupled to (e.g., attached, removably or not) or adjacent to a portion of the vehicle (e.g., a mirror (e.g., mirror 514 of FIGS. 5A-5C), a side panel, a fender, etc.).

The process also includes determining (block 1004) a modified field of view of the sensor, wherein the modified field of view is narrower than the field of view (e.g., does not include the vehicle), and wherein the determining is based on at least identifying one or more regions in the field of view that include the target (e.g., determining a boundary between the target and a portion of the vehicle).

In some embodiments, determining the modified field of view includes identifying, based on the data characterizing detection of the target, a calibration azimuth angle, wherein the calibration azimuth angle is associated with a boundary between the target and the portion of the vehicle, wherein the calibration dataset includes the calibration azimuth angle. In some embodiments, identifying the calibration azimuth angle is based on a difference in reflectivity of a beam between the target and the portion of the vehicle, wherein the beam is generated by the sensor. In some embodiments, the process also includes generating the data characterizing detection of the target. Generating the data includes directing the beam from the sensor at a plurality of azimuth angles relative to the sensor and detecting reflection of at least a portion of the beam.

The process also includes providing (block 1006) a calibration dataset (e.g., instructions for turning off beams, ignoring data from a selection of beams, etc.) that includes data associated with the modified field of view.

In some embodiments, the process also includes conforming the target to the portion of the vehicle.

In some embodiments, the target includes at least a first region of high reflectivity and a second region of low reflectivity.

In some embodiments, the process also includes receiving, by the sensor, data representing the calibration azimuth angle, and modifying the field of view of the sensor based on the calibration azimuth angle by removing at least a portion of the field of view located at an angle greater than the calibration azimuth angle. In some embodiments, the at least a portion of the field of view includes a portion of the field of view overlapping the vehicle.

Further non-limiting aspects or embodiments are set forth in the following numbered clauses:

Clause 1: A method, comprising: receiving, using at least one processor, data characterizing detection of a target by a LiDAR sensor, wherein the target is located within a field of view of detection of the sensor, and wherein the target and the sensor are coupled to or adjacent to a portion of the vehicle, determining, using the at least one processor, a modified field of view of the sensor, wherein the modified field of view is narrower than the field of view, and wherein the determining is based on at least identifying one or more regions in the field of view that include the target; and providing, using the at least one processor, a calibration dataset that includes data associated with the modified field of view.

Clause 2: The method of clause 2, wherein determining the modified field of view comprises: identifying, based on the data characterizing detection of the target, a calibration azimuth angle, wherein the calibration azimuth angle is associated with a boundary between the target and the portion of the vehicle, wherein the calibration dataset includes the calibration azimuth angle.

Clause 3: The method of clause 2, wherein identifying the calibration azimuth angle is based on a difference in reflectivity of a beam between the target and the portion of the vehicle, wherein the beam is generated by the sensor.

Clause 4: The method of clause 3, further comprising generating the data characterizing detection of the target, wherein the generating includes directing the beam from the sensor at a plurality of azimuth angles relative to the sensor and detecting reflection of at least a portion of the beam.

Clause 5: The method of any of clauses 1-4, further comprising conforming the target to the portion of the vehicle.

Clause 6: The method of any of clauses 1-5, further comprising receiving, by the sensor, data representing the calibration azimuth angle and modifying the field of view of the sensor based on the calibration azimuth angle by removing at least a portion of the field of view located at an angle greater than the calibration azimuth angle.

Clause 7: The method of clause 6, wherein the at least a portion of the field of view includes a portion of the field of view overlapping the vehicle.

Clause 8: The method of any of clauses 1-7, wherein the LIDAR sensor has a 360 degree field of view.

Clause 9: The method of any of clauses 1-8, wherein the target includes at least a first region of high reflectivity and a second region of low reflectivity.

Clause 10: The method of any of clauses 1-9, wherein providing the calibration data set comprises providing instructions for the LiDAR sensor to generate a point cloud based on the modified view.

Clause 11: The method of any of clauses 1-10, wherein determining the calibration data set comprises pre-processing, using the at least one processor, a point cloud corresponding to the field of view.

Clause 12: A system, comprising: at least one processor, and at least one memory storing instructions thereon that, when executed by the at least one processor, cause the at least one processor to carry out operations comprising: receiving, using at least one processor, data characterizing detection of a target by a LiDAR sensor, wherein the target is located within a field of view of detection of the sensor, and wherein the target and the sensor are coupled to or adjacent to a portion of the vehicle, determining, using the at least one processor, a modified field of view of the sensor, wherein the modified field of view is narrower than the field of view, and wherein the determining is based on at least identifying one or more regions in the field of view that include the target, and providing, using the at least one processor, a calibration dataset that includes data associated with the modified field of view.

Clause 13: The system of clause 12, wherein determining the modified field of view comprises: identifying, based on the data characterizing detection of the target, a calibration azimuth angle, wherein the calibration azimuth angle is associated with a boundary between the target and the portion of the vehicle, wherein the calibration dataset includes the calibration azimuth angle.

Clause 14: The system of clause 13, wherein identifying the calibration azimuth angle is based on a difference in reflectivity of a beam between the target and the portion of the vehicle, wherein the beam is generated by the sensor.

Clause 15: The system of clause 14, further comprising generating the data characterizing detection of the target, wherein the generating includes directing the beam from the sensor at a plurality of azimuth angles relative to the sensor and detecting reflection of at least a portion of the beam.

Clause 16: The system of any of clauses 12-15, wherein the target is configured to conform to the portion of the vehicle.

Clause 17: The system of any of clauses 12-16, further comprising receiving, by the sensor, data representing the calibration azimuth angle and modifying the field of view of the sensor based on the calibration azimuth angle by removing at least a portion of the field of view located at an angle greater than the calibration azimuth angle.

Clause 18: The system of clause 17, wherein the at least a portion of the field of view includes a portion of the field of view overlapping the vehicle.

Clause 19: The system of any of clauses 12-18, wherein the LIDAR sensor has a 360 degree field of view.

Clause 20: The system of any of clauses 12-19, wherein the target includes at least a first region of high reflectivity and a second region of low reflectivity.

Clause 21: At least one non-transitory computer readable medium comprising instructions stored thereon that, when executed by at least one processor, cause the at least one processor to carry out operations comprising: receiving, using at least one processor, data characterizing detection of a target by a LiDAR sensor, wherein the target is located within a field of view of detection of the sensor, and wherein the target and the sensor are coupled to or adjacent to a portion of the vehicle, determining, using the at least one processor, a modified field of view of the sensor, wherein the modified field of view is narrower than the field of view, and wherein the determining is based on at least identifying one or more regions in the field of view that include the target, and providing, using the at least one processor, a calibration dataset that includes data associated with the modified field of view.

Clause 22: The non-transitory computer readable medium of clause 21, wherein determining the modified field of view comprises: identifying, based on the data characterizing detection of the target, a calibration azimuth angle, wherein the calibration azimuth angle is associated with a boundary between the target and the portion of the vehicle, wherein the calibration dataset includes the calibration azimuth angle.

Clause 23: The non-transitory computer readable medium of clause 22, wherein identifying the calibration azimuth angle is based on a difference in reflectivity of a beam between the target and the portion of the vehicle, wherein the beam is generated by the sensor.

Clause 24: The non-transitory computer readable medium of clause 23, further comprising generating the data characterizing detection of the target, wherein the generating includes directing the beam from the sensor at a plurality of azimuth angles relative to the sensor and detecting reflection of at least a portion of the beam.

Clause 25: The non-transitory computer readable medium of any of clauses 21-24, wherein the target is configured to conform to the portion of the vehicle.

Clause 26: The non-transitory computer readable medium of clause 25, further comprising: receiving, by the sensor, data representing the calibration azimuth angle and modifying the field of view of the sensor based on the calibration azimuth angle by removing at least a portion of the field of view located at an angle greater than the calibration azimuth angle.

Clause 27: The non-transitory computer readable medium of clause 26, wherein the at least a portion of the field of view includes a portion of the field of view overlapping the vehicle.

Clause 28: The non-transitory computer readable medium of any of clauses 21-27, wherein the LIDAR sensor has a 360 degree field of view.

Clause 29: The non-transitory computer readable medium of any of clauses 21-28, wherein the target includes at least a first region of high reflectivity and a second region of low reflectivity.

In the foregoing description, aspects and embodiments of the present disclosure have been described with reference to numerous specific details that can vary from implementation to implementation. Accordingly, the description and drawings are to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction. Any definitions expressly set forth herein for terms contained in such claims shall govern the meaning of such terms as used in the claims. In addition, when we use the term “further comprising,” in the foregoing description or following claims, what follows this phrase can be an additional step or entity, or a sub-step/sub-entity of a previously-recited step or entity.

What is claimed is:

1-13. (canceled)

14. A method, comprising:
receiving, using at least one processor, data characterizing detection of a target by a LiDAR sensor, wherein the target is located within a field of view of detection of the sensor, and wherein the target and the sensor are coupled to or adjacent to a portion of the vehicle;
determining, using the at least one processor, a modified field of view of the sensor, wherein the modified field of view is narrower than the field of view, and wherein the determining is based on at least identifying one or more regions in the field of view that include the target; and
providing, using the at least one processor, a calibration dataset that includes data associated with the modified field of view.

15. The method of claim 14, wherein determining the modified field of view comprises:
identifying, based on the data characterizing detection of the target, a calibration azimuth angle, wherein the calibration azimuth angle is associated with a boundary between the target and the portion of the vehicle, wherein the calibration dataset includes the calibration azimuth angle.

16. The method of claim 15, wherein identifying the calibration azimuth angle is based on a difference in reflectivity of a beam between the target and the portion of the vehicle, wherein the beam is generated by the sensor.

17. The method of claim 16, further comprising generating the data characterizing detection of the target, wherein the generating includes:
directing the beam from the sensor at a plurality of azimuth angles relative to the sensor; and
detecting reflection of at least a portion of the beam.

18. The method of claim 15, further comprising:
receiving, by the sensor, data representing the calibration azimuth angle;
modifying the field of view of the sensor based on the calibration azimuth angle by removing at least a portion of the field of view located at an angle greater than the calibration azimuth angle.

19. The method of claim 18, wherein the at least a portion of the field of view includes a portion of the field of view overlapping the vehicle.

20. The method of claim 14, further comprising conforming the target to the portion of the vehicle.

21. The method of claim 14, wherein the LiDAR sensor has a 360 degree field of view.

22. The method of claim 14, wherein the target includes at least a first region of high reflectivity and a second region of low reflectivity.

23. The method of claim 14, wherein providing the calibration data set comprises providing instructions for the LiDAR sensor to generate a point cloud based on the modified view.

24. The method of claim 14, wherein determining the calibration data set comprises pre-processing, using the at least one processor, a point cloud corresponding to the field of view.

25. A system comprising:
at least one computer-readable medium storing computer-executable instructions;
one or more processors configured to execute the computer executable instructions comprising:
receiving, using the one or more processors, data characterizing detection of a target by a LiDAR sensor, wherein the target is located within a field of view of detection of the sensor, and wherein the target and the sensor are coupled to or adjacent to a portion of the vehicle;
determining, using the one or more processors, a modified field of view of the sensor, wherein the modified field of view is narrower than the field of view, and wherein the determining is based on at least identifying one or more regions in the field of view that include the target; and
providing, using the one or more processors, a calibration dataset that includes data associated with the modified field of view.

26. A non-transitory computer-readable storage medium comprising at least one program for execution by one or more processors of a first device, the at least one program including instructions which, when executed by the one or more processors, cause the first device to perform the steps of:
receiving, using the one or more processors, data characterizing detection of a target by a LiDAR sensor, wherein the target is located within a field of view of detection of the sensor, and wherein the target and the sensor are coupled to or adjacent to a portion of the vehicle;
determining, using the one or more processors, a modified field of view of the sensor, wherein the modified field of view is narrower than the field of view, and wherein the determining is based on at least identifying one or more regions in the field of view that include the target; and
providing, using the one or more processors, a calibration dataset that includes data associated with the modified field of view.
